(19) United States
(12) Patent Application Publication
(10) Pub. No.: US 2018/0099843 A1
(43) Pub. Date: Apr. 12, 2018

(54) DRILLING, PLUG, ABANDONMENT, AND DECOMMISSIONING

(71) Applicant: ZENTECH, INC., Houston, TX (US)

(72) Inventors: Ramesh MAINI, Houston, TX (US); Hans DEUL, Richmond, TX (US)

(21) Appl. No.: 15/727,440

(22) Filed: Oct. 6, 2017

Related U.S. Application Data
(60) Provisional application No. 62/405,619, filed on Oct. 7, 2016.

(51) Int. Cl. B66C 23/18; E21B 15/00; E21B 19/00; E02B 17/08; B66C 23/60

(52) U.S. Cl. CPC B66C 23/18; E21B 15/003; B66C 23/53; E02B 17/0836; B66C 23/60; E21B 19/008

(57) ABSTRACT

The present disclosure generally relates to jack-up units employing a multi-purpose derrick structure for drilling, plug, abandonment, and decommissioning operations. The multi-purpose derrick structure includes a mast that may be vertically oriented in a first configuration to facilitate drilling, plug, and abandonment procedures, or may be pivotably positioned in a second configuration for decommissioning operations or other procedures. In the pivoting position, the mast functions as a heavy lift crane. One or more selective pivoting structures at the base of the multi-purpose derrick structure, and one or more actuators, facilitate the multiple uses of the multi-purpose derrick structure.

### CROSS-REFERENCE TO RELATED APPLICATIONS

This application claims benefit of U.S. Provisional Patent Application Ser. No. 62/405,619, filed Oct. 7, 2016, which is herein incorporated by reference.

### BACKGROUND

### Field

Embodiments of the present disclosure generally relate to offshore jack-up units, and more particularly, to jack-up units for drilling, plugging, abandonment, and decommissioning of wells.

### Description of the Related Art

A jack-up unit is designed to drill exploratory wells at predefined locations in the sea. The jack-up unit performs the services of drilling, workover, well intervention, or completing pre-drilled wells using a mast or derrick located on the jack-up unit. The jack-up unit may also include a large crane installed thereon for decommissioning operations.

However, in order for a jack-up unit to be able to perform both completions and decommissions of wells, conventional jack-up units require both the derrick and one or more large cranes. The inclusion of both the derrick and the large cranes increases expenses of the jack-up unit due to increased construction, maintenance, and operating costs. Additionally, labor and safety-related costs may also increase due to required relocation of either or both the derrick and the large crane on the jack-up unit to facilitate adequate spacing for operations.

Therefore, there is a need for an improved apparatus for offshore operations.

### SUMMARY

The present disclosure generally relates to jack-up units employing a multi-purpose derrick structure for drilling, plug, abandonment, and decommissioning operations. The multi-purpose derrick structure includes a mast that may be vertically oriented in a first configuration to facilitate drilling, plug, and abandonment procedures, or may be pivotably positioned in a second configuration for decommissioning operations or other procedures. In the pivoting position, the mast functions as a heavy lift crane. One or more selective pivoting structures at the base of the multi-purpose derrick structure, and one or more actuators, facilitate the multiple uses of the multi-purpose derrick structure.

In one embodiment, a multi-purpose derrick structure comprises a pivoting mast which pivots about a point at a lower end of the mast, the mast configured to function as a derrick in a first positon, and configured to function as a heavy lift crane in a second position different than the first position.

In another embodiment, an off-shore platform comprises a deck; a plurality of jack-up legs for supporting the deck; a cantilever structure disposed on the deck; and a pivoting mast disposed on the cantilever structure, the pivoting mast pivotable about a point at a lower end of the mast, the mast configured to function as a derrick in a first positon, and configured to function as a heavy lift crane in a second position different than the first position.

In another embodiment, a method of performing offshore operations on an offshore vessel, comprises performing a first operation with a mast located on a cantilever structure, wherein in the first position the mast functions as a derrick; pivoting the mast to a second position angularly displaced from the first position; and performing a lifting operation with the mast while in the second position.

### BRIEF DESCRIPTION OF THE DRAWINGS

So that the manner in which the above recited features of the present disclosure can be understood in detail, a more particular description of the disclosure, briefly summarized above, may be had by reference to embodiments, some of which are illustrated in the appended drawings. It is to be noted, however, that the appended drawings illustrate only exemplary embodiments and are therefore not to be considered limiting of scope, as the disclosure may admit to other equally effective embodiments.

FIGS. 1A and 1B are schematic plan views of an offshore platform, according to one aspect of the disclosure.

FIGS. 2A and 2B are schematic side views of a cantilever structure, according to one aspect of the disclosure.

FIG. 2C is schematic side view of a cantilever structure, according to another aspect of the disclosure.

FIGS. 3A and 3B represent the abilities of the multi-purpose derrick structure to function as a heavy lift crane, according to aspects of the disclosure.

To facilitate understanding, identical reference numerals have been used, where possible, to designate identical elements that are common to the figures. It is contemplated that elements and features of one embodiment may be beneficially incorporated in other embodiments without further recitation.

### DETAILED DESCRIPTION

The present disclosure generally relates to jack-up units employing a multi-purpose derrick structure for drilling, plug, abandonment, and decommissioning operations. The multi-purpose derrick structure includes a mast that may be vertically oriented in a first configuration to facilitate drilling, plug, and abandonment procedures, or may be pivotably positioned in a second configuration for decommissioning operations or other procedures. In the pivoting position, the mast functions as a heavy lift crane. One or more selective pivoting structures at the base of the multi-purpose derrick structure, and one or more actuators, facilitate the multiple uses of the multi-purpose derrick structure.

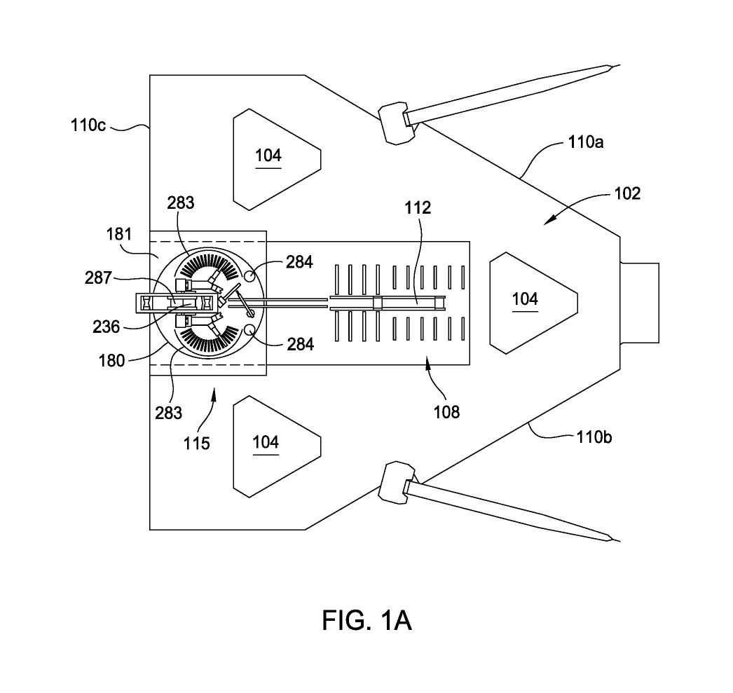

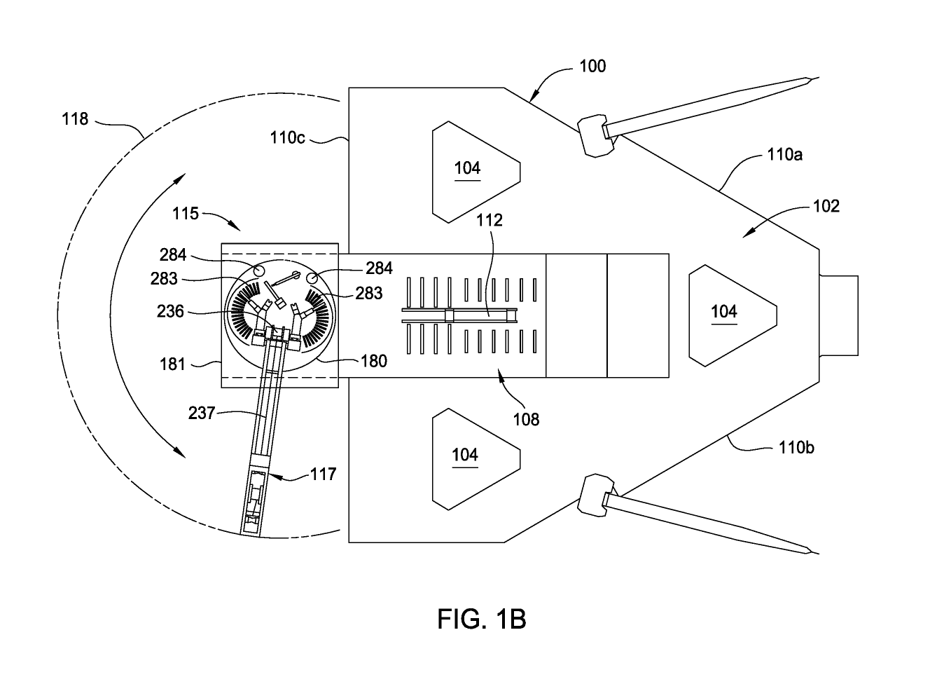

FIGS. 1A and 1B are schematic plan views of an offshore platform, according to one aspect of the disclosure. In one example, the offshore platform 100 may be a jack-up unit, as illustrated. The offshore platform 100 includes a deck 102 supported by a plurality of jack-up legs 104 (three are shown). The jack-up legs 104 engage a seafloor beneath the offshore platform 100 to support the deck 102 above a water line. While the deck 102 is illustrated as triangular with jack-up legs 104 positioned near each of the vertices, other configurations are also contemplated.

The offshore platform 100 also includes one or more light-purpose cranes 106 (two are shown) and a cantilever structure 108. The light-purpose cranes 106 are located midway along adjacent edges 110a, 110b of the deck 102 and facilitate movement of smaller, light weight objects about the deck 102. The cantilever structure 108 is positioned to extend over the remaining edge 110c of the deck 102. The cantilever structure 108 includes a track 112 (partially shown) on an underside thereof to facilitate longitudinal movement of the cantilever structure 108. The track 112 or the cantilever structure 108 may be actuatable about a point to facilitate rotational movement of the cantilever structure 108 relative to the deck 102. FIG. 1A illustrates the cantilever structure 108 in a retracted position, while FIG. 1B illustrates the cantilever structure 108 in an extended or cantilevered position relative to the deck 102.

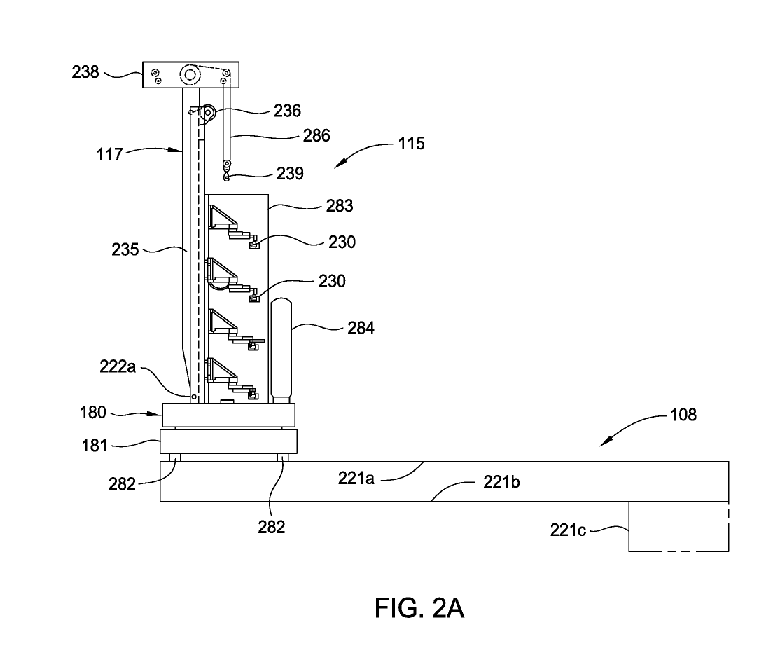

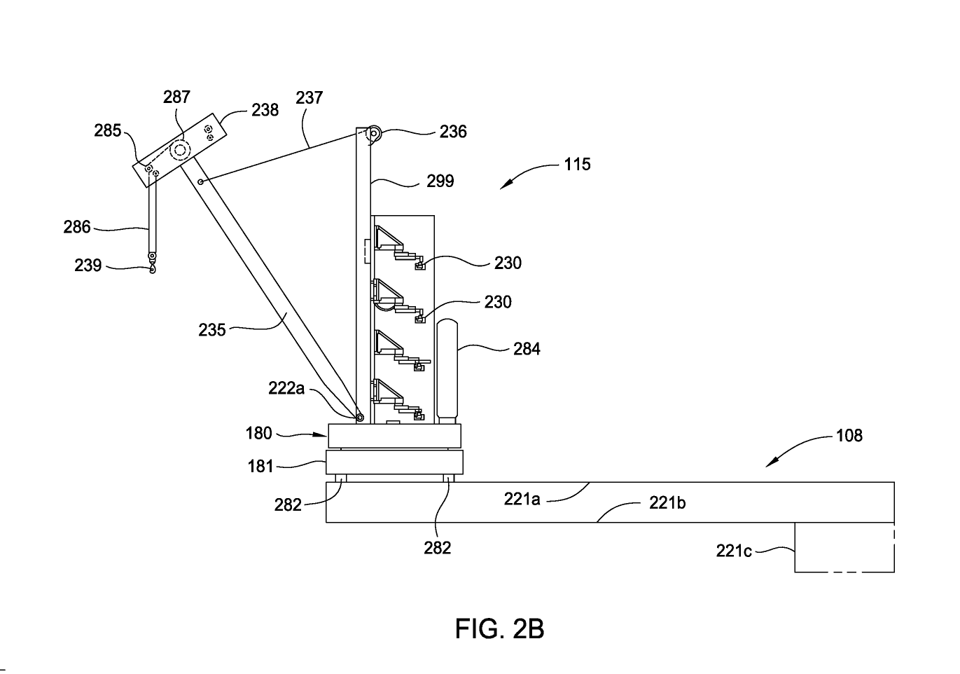

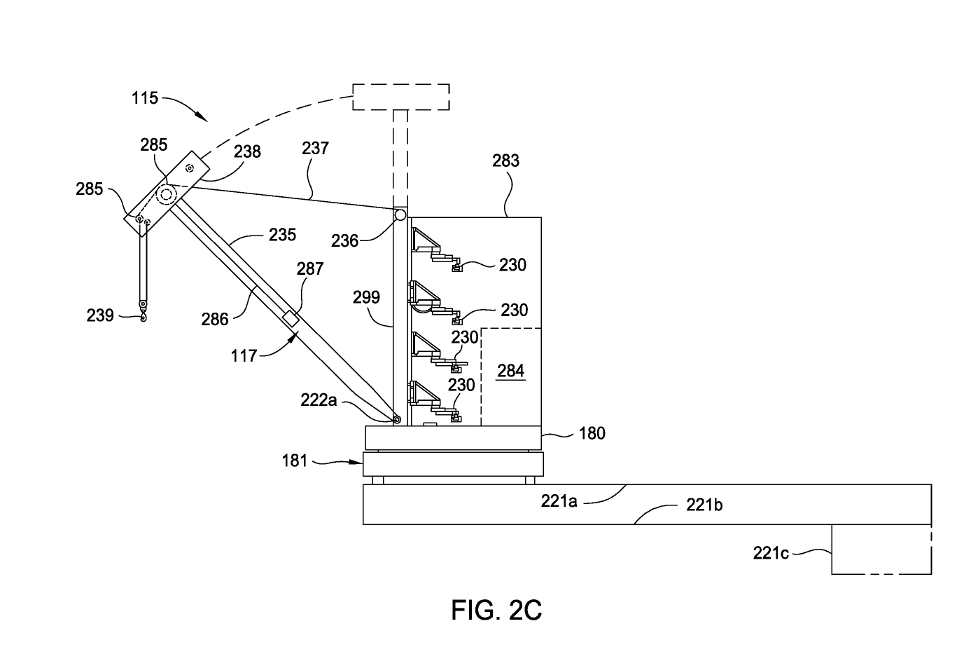

The cantilever structure 108 includes an operational end 115 having a drilling station 116 coupled thereto. The drilling station 116 is rotatable independently of and relative to the cantilever structure 108 on a turntable 180. The turntable 180 is positioned on a table 181. The table 181 moves perpendicularly to the longitudinal axis of the cantilever structure 108, thereby moving the turntable 180 and the drilling station 116. In one example, the drilling station 116 is generally aligned with the cantilever structure 108 during drilling operations. The drilling station 116 includes a multi-purpose derrick structure 117. The multi-purpose derrick structure 117 includes a mast 235 (shown in FIGS. 2A and 2B) which is actuatable between a vertical position and a horizontal or nearly horizontal position, and any angle therebetween. In the vertical position, e.g., about 90 degrees (shown in FIG. 2A) relative to the upper surface of the cantilever structure 108, the mast 235 of the multi-purpose derrick structure 117 functions as a conventional derrick to facilitate drilling operations. However, the multi-purpose derrick structure 117 is also capable of performing other operations, such as lifting operations, when the mast 235 positioned in a non-vertical orientation, such as at an angle less than about 90 degrees relative to the upper surface of the cantilever structure 108 or other surface on which the mast 235 is disposed.

The mast 235 of the multi-purpose derrick structure 117 may be positioned at an angle less than 90 degrees relative to the upper surface of the cantilever structure 108, for example about 30 degrees to about 80 degrees, such as about 45 degrees. Other angles are also contemplated. In such a position, the mast 235 acts as a crane boom, thereby providing the functionality of a heavy lift crane. The rotational and longitudinal actuation of the cantilever structure 108, in combination with the rotational actuation of the drill floor 116 and the pivoting actuation of the multi-purpose derrick structure 117, greatly increase the effective range of crane activities relative to conventional cranes and platforms. The effective range of the multi-purpose derrick structure 117 is shown by arc 118, which may be about 200 degrees to about 220 degrees. In one example, the mast 235 is about 115 feet in length, but other lengths are also contemplated.

In addition to increased range, the multi-purpose derrick structure 117 significantly reduces construction, maintenance, and operating costs due to the elimination of a dedicated heavy lift crane. Simultaneous drilling operations are rarely performed during decommissioning, and thus, a multi-purpose derrick structure 117 that can perform both operations reduces costs and saves space. Additionally, labor and safety-related costs are also reduced, because relocation of either or both of a conventional derrick and or a conventional large crane is no longer required. Elimination of a conventional dedicated heavy lift crane mitigates the need to reposition derricks/cranes to provide adequate crane clearance due to derrick interference.

While FIG. 1 illustrates one example of an offshore platform 100, other examples, such as semi-submersible rigs, mono-hull drilling vessel, tension leg towers, spar buoy rigs, and the like, are also contemplated.

FIGS. 2A and 2B are schematic side views of a cantilever structure, according to one aspect of the disclosure. The cantilever structure 108 includes one or more levels 221a, 221b, and 221c (three are shown) upon which equipment and personnel may operate. The multi-purpose derrick structure 117 is posited on an upper level 221a of the cantilever structure 108 at the operation end 115 thereof. An actuatable table 181 is positioned on the upper level 221a of the cantilever structure 108. The actuatable table 181 is adapted to move perpendicular to the longitudinal axis of the cantilever structure 108. The actuatable table 181 is positioned on parallel rails 282 to facilitate movement of the table 181 relative to the upper level 221a. The turntable 180 may be disposed upon or recessed into the actuatable table 181 to facilitate rotational movement of the multi-purpose derrick structure 117 about a vertical axis. The multi-purpose derrick structure 117 includes one or more manipulators 230 (four are shown) and a hoisting mechanism 239 to facilitate hydrocarbon production.

In another example, the cantilever structure 108 may not be a multiple level structure. In such an example, the level 221a may represent an upper surface of the cantilever structure 108, the level 221b may represent a lower surface of the cantilever structure 108, and the level 221c may represent a portion of the deck 102. Other configurations are also contemplated.

The mast 235 of the multi-purpose derrick structure 117 is coupled to the turntable 180 by one or more hinges 222a (one is shown). The hinge 222a allows rotation of the mast 235 about an axis of the hinge 222a, thereby allowing the mast 235 to be positioned at an angle between vertical (90 degrees) and horizontal (0 degrees). Stop pins or other locks (not shown) may be used to prevent rotation about the hinges 222a when angular rotation is not desired.

A setback 283 is positioned adjacent to the mast 235. The setback 283 facilitates storage of pipe during drilling operations. One or more ballast tanks 284 may be positioned next to, or coupled to, the setback 283. The ballast tanks 284 may be filled with fluid, such as sea water or drilling mud, to act as a counter balance when the mast 235 is not in a vertical orientation, e.g., when operating as a heavy lift crane. As illustrated, the ballast tanks 284 may be positioned exterior to, or interior of, the setback 283. A vertical support 299 is posited adjacent to the setbacks on the actuatable table 180. It is contemplated that the vertical support 299 may be excluded in some embodiments.

FIG. 2B illustrates the multi-purpose derrick structure 117 in a heavy lift crane positon. In the heavy lift crane position, a mast 235 of the multi-purpose derrick structure 117 is pivoted outboard on the hinge 222a. An actuator 236, such as a hydraulic actuator or cable winch, facilitates outboard pivoting of the mast 235. The actuator 236 may be coupled to the vertical 299 support (as shown), the setback 283, or the cantilever 108. A coupling cable 237 facilitates connection of the mast 235 to the actuator 236 to control pivoting of the mast 235. Actuation of the coupling cable 237 via the actuator 236 results in inboard or outboard pivoting of the mast 235. Stops (not shown) are positioned adjacent a base of the setback 283 to prevent the mast 235 from pivoting beyond vertical when retracting the coupling cable 237.

The mast 235 includes a crown block 238. The crown block 238 facilitates vertical actuation of a hoisting mechanism 239, and thus drill string or other tubulars coupled thereto, when the mast 235 is vertically oriented. The crown block 238 includes one or more pulleys 285 through which a cable 286 may be rigged. The cable 286 is coupled to an actuator 287, such as a winch or drive motor, to facilitate actuation of the cable 286. The actuator 287 may be coupled to the mast 235, the crown block 238, or disposed on the cantilever or deck of the offshore platform. In one example, the hoisting mechanism 239 is a hook or other gripping mechanism. Prior to pivoting the mast 235 into the crane position, the cable 286 may be re-rigged from a first side (shown in FIG. 2A) used for drilling operations, to a second side (shown in FIG. 2B) used for crane operations. In such a manner, drilling and crane operations may be performed using a single actuator 287, rather than separate actuators for individual operations, thereby reducing costs. Additionally, prior to or after pivoting the mast 235, the ballast tank 284 may be filled with a desired amount of fluid to counter the push off of the table 181 during lift operations.

The multi-purpose derrick structure 117 reduces the amount of equipment required to perform drilling, plug, abandonment, and decommissioning operations by eliminating the need for a dedicated heavy lift crane. During operation, the mast 235 of the multi-purpose derrick structure 117 is vertically oriented to facilitating drilling of wells or paying out of tubulars. Additionally, as desired, the mast 235 may be pivoted outboard at an acute angle relative to the cantilever structure 108. In such a position, the hoisting mechanism 239 and the crown block 238 function as a heavy lift crane, allowing decommissioning operations to be performed. In one example, decommissioning operations may include removal of equipment from the subsea floor. The multi-purpose derrick structure 117 may then position the equipment or structures directly on a barge for transportation from the well sight. While conventional derricks may be able to be positioned at an acute angle to facilitate drilling operations, the conventional derricks are generally fixed in this position, and thus, the relative angle to vertical is not adjustable. Moreover, such derricks are incapable of performing heavy lift operations.

FIG. 2C is schematic side view of a cantilever structure, according to another aspect of the disclosure. In FIG. 2C, the one or more ballast tanks 284 (shown in phantom) are positioned radially inward of the setback 283. Additionally, the vertical support 299 has a reduced height compared to the vertical support 299 of FIG. 2B, illustrating that the height of the vertical support 299 may be varied to accommodate different configurations. In the illustrated example, the vertical support has a height about equal to the height of the setback 283. Moreover, in FIG. 2C, the actuator 287 is coupled to the mast 235 rather than the crown block 238. Other locations for the actuator 287 are also contemplated, such as on an upper surface of the turntable 180.

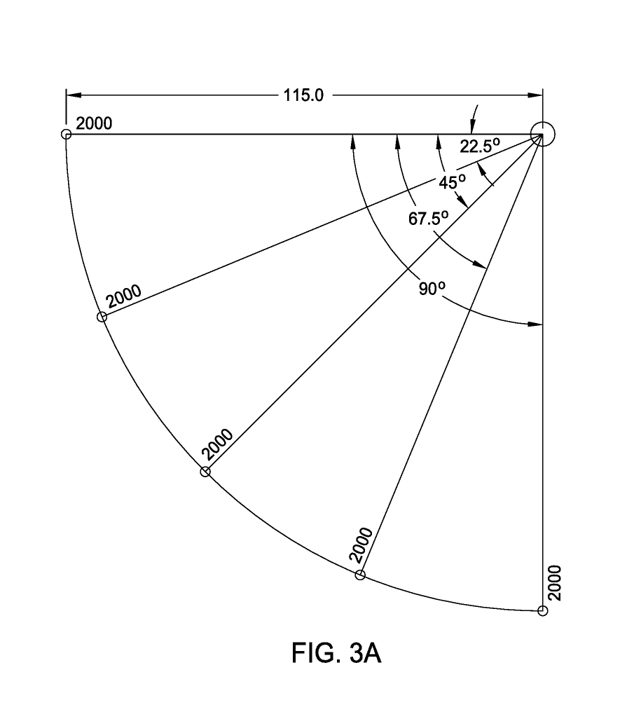

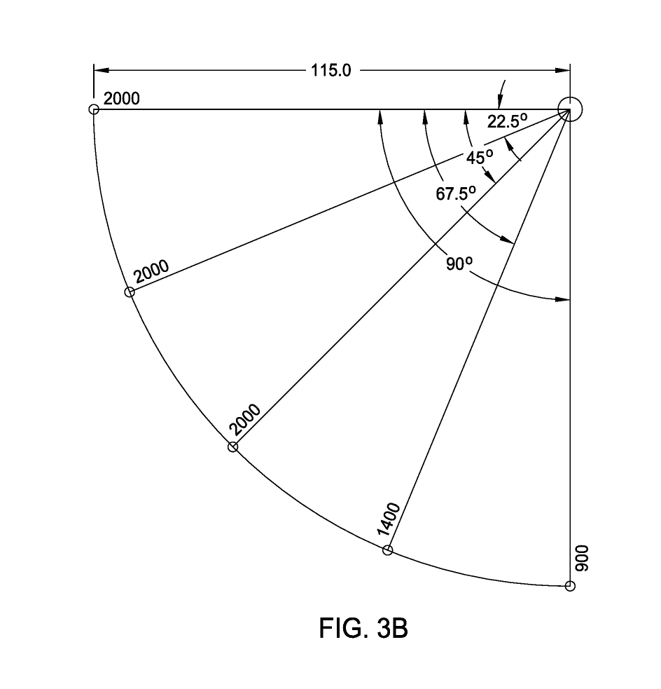

FIGS. 3A and 3B represent the abilities of the multi-purpose derrick structure to function as a heavy lift crane positioned at various horizontal angles (e.g., boom angles), according to aspects of the disclosure. Specifically, FIGS. 3A and 3B illustrate permissible crane thrust for various configurations. The illustrated examples assume a maximum crane thrust of 2,000 kips at a 115 foot long mast weighing 800 kips.

In the example illustrated in FIG. 3A, the cantilever beams are unrestricted against pushup at uplift. FIG. 3A illustrates permissible crane thrust at various angles for such a configuration (loads in kip, distance in feet, angle representing horizontal angle of mast). In the example illustrated in FIG. 3B, the cantilever beams are held against uplift at push off. FIG. 3B illustrates crane loads at various angles for such a configuration (loads in kip, distance in feet, angle representing horizontal angle of mast). As illustrated in FIGS. 3A and 3B, the multi-purpose derrick structure 117 is capable of lifting loads comparable to most heavy lift cranes, while still providing the functionality of conventional derricks.

While the foregoing is directed to embodiments of the present disclosure, other and further embodiments of the disclosure may be devised without departing from the basic scope thereof, and the scope thereof is determined by the claims that follow.

What is claimed is:

1. A multi-purpose derrick structure, comprising:
a pivoting mast which pivots about a point at a lower end of the mast, the mast configured to function as a derrick in a first positon, and configured to function as a heavy lift crane in a second position different than the first position.

2. The multi-purpose derrick structure of claim 1, further comprising a cantilever structure on which the pivoting mast is disposed.

3. The multi-purpose crane structure of claim 2, wherein the mast is positioned perpendicular to an upper surface of the cantilever structure in the first position, and positioned at an angle other than the perpendicular to the upper surface of the cantilever structure in the second positon.

4. The multi-purpose derrick structure of claim 2, wherein the cantilever structure is configured to actuate longitudinally and rotationally.

5. The multi-purpose derrick structure of claim 1, further comprising turntable positioned on a table, wherein the pivoting mast is coupled to an upper surface of the turntable.

6. The multi-purpose derrick structure of claim 5, further comprising a cantilever structure on which the table is disposed.

7. The multi-purpose derrick structure of claim 1, further comprising a vertical support positioned adjacent the mast, the vertical support including an actuator coupled thereto, wherein a cable extends between the actuator and the mast to facilitate angular displacement of the mast.

8. The multi-purpose derrick structure of claim 7, further comprising a turntable positioned on a table, wherein the pivoting mast is coupled to an upper surface of the turntable.

9. The multi-purpose derrick structure of claim 8, further comprising a setback positioned on the turntable adjacent the mast and the vertical support.

10. The multi-purpose derrick structure of claim 9, further comprising rails upon which the turntable is positioned and movable thereon.

11. The multi-purpose derrick structure of claim 9, further comprising one or more ballast tanks positioned on the turntable adjacent the setback.

12. An off-shore platform, comprising:
a deck;
a plurality of jack-up legs for supporting the deck;
a cantilever structure disposed on the deck; and
a pivoting mast disposed on the cantilever structure, the pivoting mast pivotable about a point at a lower end of the mast, the mast configured to function as a derrick in a first positon, and configured to function as a heavy lift crane in a second position different than the first position.

13. The off-shore platform of claim 12, further comprising a vertical support positioned adjacent the mast, the vertical support including an actuator coupled thereto, wherein a cable extends between the actuator and the mast to facilitate angular displacement of the mast.

14. The off-shore platform of claim 13, further comprising a turntable positioned on a table, wherein the pivoting mast is coupled to an upper surface of the turntable.

15. The off-shore platform of claim 14, further comprising a setback positioned on the turntable adjacent the mast and the vertical support.

16. The off-shore platform of claim 15, further comprising rails upon which the turntable is positioned and movable thereon.

17. The off-shore platform of claim 16, further comprising one or more ballast tanks positioned on the turntable adjacent the setback.

18. A method of performing offshore operations on an offshore vessel, comprising:
performing a first operation with a mast located on a cantilever structure, wherein in the first position the mast functions as a derrick;
pivoting the mast to a second position angularly displaced from the first position; and
performing a lifting operation with the mast while in the second position.

19. The method of claim 18, further comprising extending the cantilever structure horizontally beyond an edge of a deck of the offshore platform prior to performing the lifting operation.
